(19) United States
(12) Patent Application Publication
(10) Pub. No.: US 2022/0234843 A1
(43) Pub. Date: Jul. 28, 2022

(54) Personal Delivery Mail System

(71) Applicant: Reokas J. Cumby Beeks, Greenville, SC (US)

(72) Inventor: Reokas J. Cumby Beeks, Greenville, SC (US)

(21) Appl. No.: 17/549,990

(22) Filed: Dec. 14, 2021

Related U.S. Application Data
(60) Provisional application No. 63/142,159, filed on Jan. 27, 2021.

(51) Int. Cl. B65G 51/40; B65G 51/28; B65G 51/34

(52) U.S. Cl. CPC B65G 51/40; B65G 51/06; B65G 51/34; B65G 51/28

(57) ABSTRACT

The present invention relates to a reversible force pneumatic mail delivery system. The system includes a mailbox, a pneumatic tube, one or more courier canisters, a receiving slot, a tablet for monitoring the system and receiving notifications and a scanner positioned near a front door of the house. The mailbox and the receiving slot are connected through the pneumatic tube and the canister stores mail or other items for travel through the pneumatic tube. A compressor propels the canister from the mailbox to the receiving slot enabling a resident or user to receive incoming items and propels the canister from the receiving slot to the mailbox for sending an outgoing mail. The scanner is used for scanning a package and providing notifications of the scan are provided on the tablet.

### CROSS-REFERENCE TO RELATED APPLICATION

The present application claims priority to, and the benefit of, U.S. Provisional Application No. 63/142,159, which was filed on Jan. 27, 2021 and is incorporated herein by reference in its entirety.

### FIELD OF THE INVENTION

The present invention relates generally to the field of personal communication delivery systems. More specifically, the present invention relates to a mail or other parcel delivery system featuring a pneumatic tube system that is designed to deliver packages, other parcels, communications and envelopes directly into the home, residence, office or other delivery location. More specifically, the system has a collection receptacle such as mailbox installed outside a house and a receiving box, area or slot inside the receiving location. The pneumatic tube system is powered by a compressor that propels a courier canister or tube that holds mail, parcels and other communications between the receiving receptacle and receiving slot, box or area. The system also has a scanner or reader positioned near the front door of the house for a courier to scan a bar code on a package or reader to read an RFID tag and also a tablet that enables the homeowner or other intended recipient to receive real-time notifications of mail, deliveries and packages in the receiving receptacle or mailbox and at the scanner or reader. Accordingly, the present disclosure makes specific reference thereto. Nonetheless, it is to be appreciated that aspects of the present invention are also equally applicable to other like applications, devices and methods of manufacture.

### BACKGROUND

By the way of background, in the field of postal, courier, other delivery services and conventional postal offerings, receptacles such as mailboxes are well-known in art. Conventional delivery boxes such as mailboxes, typically have a round-shaped container with a locking mechanism for receiving the mail or packages. Other shapes are of course available, as long as they meet general specifications and requirements of the delivery service or local ordinances. Mailboxes and other delivery receptacles remain susceptible to thefts and other intrusions, as the delivery receptacle is typically positioned in a publicly available area, such as near a street to enable easy access by the delivery personnel. Further, to identify if any mail or packages have been received, individuals or homeowners often have to make multiple trips to their mailbox and check the receptacle manually to see if a delivery has been made. As the mailboxes are installed in the yard or curbside, the owner or user of the box or receptacle is required to travel a distance which can be long, due to long driveways or in the case of rural routes or neighborhoods that limit the location of boxes, the box may be located with a plurality of others at the entrance to the neighborhood or other specified area. This is time-consuming, discomforting and tiring for users. The long walk to the mailbox can be annoying particularly if made multiple times in a day to collect multiple deliveries. Also, elderly individuals and those with limited physical dexterity may struggle visiting their mailbox constantly each day. Current mailboxes, delivery receptacles and mailing systems do not provide an adequate way for viewing inside of the mailbox or determining if a package has been received without travelling to the mailboxes or receptacle.

Similarly, when the homeowners, user or residents want to send mail, packages or envelopes, the owner or user must walk to put the mail or package in the mailbox or receptacle and raise the flag on the side of the mailbox to alert the mail person that mail is to be picked up. People therefore desire a way to allow them to put the mail and other parcels in the mailbox without going to the delivery receptacle.

Also, there is no mail delivery system existing in the prior art that enables users to deliver packages and envelopes directly into the home and simultaneously receive alerts that notify a user about the status of the mail and packages and whether the anticipated delivery has occurred. Further, there is no mail delivery system that includes a scanner or reader next to the house door that allows the delivery person to scan packages or read tags and alert the courier of correct or incorrect addresses.

Therefore, there exists a long felt need in the art for a mail delivery system that can deliver packages, parcels, other communications and envelopes directly into the home or other location of the recipient. There exists a long felt need in the art for a mail delivery system and delivery receptacle that prevent people from constantly going out, looking for deliveries and retrieving mail from the mailbox. Additionally, there is a long felt need in the art for a mail delivery system which eliminates the need to travel or make long walks up driveways to the mailbox or delivery receptacle. Moreover, there is a long felt need in the art for a mailbox or delivery receptacle that notifies and alerts residents or users of the receptacle about the status of their mail or packages. Further, there is a long felt need in the art for a mail delivery system that allows homeowners to put mail and other items in the mailbox from inside the home. Furthermore, there is a long felt need in the art for a mailbox or delivery receptacle that allows homeowners to change the status of the flag or other alert indicator of the mailbox or delivery receptacle. Finally, there is a long felt need in the art for an improved mail delivery system that allows user to monitor their mailbox or delivery receptacle from inside the home and enables user to directly receive and send mail, parcels, other communications and packages directly from the home, office or other location where the user may be located.

The subject matter disclosed and claimed herein, in one embodiment thereof, comprises a pneumatic mail and package delivery system. The system features a delivery receptacle installed outside of a home, office or other location, and a receiving slot disposed inside of the receiving location. The delivery receptacle or mailbox and the receiving slot are connected to each other through a pneumatic tube with the delivery receptacle at one end and the receiving slot at the other end. The system uses a courier shuttle or canister that is sized and configured to fit inside a cavity of the delivery receptacle or mailbox and for receiving and storing at least one item such as mail, a parcel or envelope. A compressor provides a pneumatic effect in the tube, and serves to provide a constant pressure to keep the tube inflated and for pushing the canister through the pneumatic tube from the mailbox to the receiving slot while carrying the mail or parcels to the inside of the home and vice versa to carry a mail from inside of the home to the mailbox or delivery receptacle. A scanner or reader is positioned near the front door of the home, and is configured for scanning a package or reading a tag such as an RFID tag by a delivery personnel. A tablet receives notification when mail or other items are placed in a courier canister and when a package is scanned or read at the scanner or reader.

In this manner, the novel delivery system of the present invention accomplishes all of the forgoing objectives and provides a relatively convenient and efficient solution which eliminates the need for an individual to constantly go out and retrieve and send mail or other delivered items from a mailbox or delivery receptacle each day. The delivery system of the present invention provides a solution which eliminates the need for elderly individuals and those with limited physical dexterity to have to visit their mailbox and check for the mail received. The delivery system of the present invention continuously alerts the user concerning the real-time status of the mailbox or delivery receptacle to the individual at the delivery location such as the home or office.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a personal pneumatic mail and package delivery system. The system is designed to deliver packages and envelopes directly into homes of residents or other locations where users of the system are present. The system further includes a pneumatic mailbox installed outside of a home or other location of a user, and a receiving slot disposed inside of the home or user location. The pneumatic system connects a delivery receptacle such as a mailbox, to the receiving slot through a pneumatic tube. The tube includes at least one canister sized and configured to fit within a cavity of the mailbox and pneumatic tube and for receiving and storing at least one piece of mail, envelope, or parcel, a compressor for providing a pneumatic effect in the tube for pushing the canister from the mailbox to the receiving slot for carrying the mail inside of the home and vice versa. A reversible pushing force is used to carry mail from inside of the home or user location to the mailbox or delivery receptacle. A scanner or reader is positioned near the front door of the home or user location, and configured for scanning or reading a package by a delivery personnel. A tablet is provided for receiving notification when mail is placed in a courier canister while the canister is placed inside the delivery receptacle or mailbox. When a package or piece of mail is scanned or read at the scanner or reader, a control button is pushed on the tablet to provide an instruction to the compressor for pushing the canister from the delivery receptacle or mailbox to the receiving slot, thus enabling the resident or other user to receive the mail, parcel or envelops inside the home or other user location. An instruction is provided on the tablet to instruct the compressor to push a canister from the receiving slot to the mailbox for sending outgoing mail or other items.

In yet another embodiment of the present invention, a pneumatic mailbox configured to work with a pneumatic tube is disclosed. The mailbox is positioned outside a house or other user location and is communicatively-coupled with a receiving slot that is positioned inside the house. The mailbox and receiving slot are connect to one another by a pneumatic tube that works as a conduit between the receiving slot and the delivery location. The mailbox or delivery location includes a cavity for receiving a courier canister that houses one or more incoming items. A lockbox is provided that includes an emergency canister and the emergency canister is configured to be used when the cavity is not operable, so that delivered items are held safely until they can be retrieved. A processor is configured to transmit a notification to a tablet and a small light is positioned inside the house, thereby alerting the user that the courier canister stores at least one incoming item. The pneumatic mailbox along with the pneumatic tube is configured to send the courier canister having the incoming envelope or mail to the receiving slot through the tube and is also configured to receive the courier canister having the outgoing mail or envelope from the receiving slot.

In yet another embodiment of the present invention, the mailbox has a sensor for detecting mail or other items present in the mailbox. Further, the processor transmits a notification to the tablet when the sensor detects the item in the delivery receptacle.

The subject matter disclosed and claimed herein, in one embodiment thereof, comprises a mail delivery system which is designed to deliver packages and envelopes directly into the home or other user location. The mail delivery system has a pneumatic tube system which is powered by a compressor to propel a courier canister or shuttle that stores the items to be delivered to and from the mailbox and the user's location. The mail delivery system also includes a scanner or reader that enables the courier service to scan the delivery item once they deliver a package and alert the courier services of correct or incorrect address(es). The system is integrated with a sensor on the interior of the delivery receptacle or mailbox that senses when an object is inside of the mailbox and activates a small light to turn on inside of the home or user location to alert the resident or user that they have received an item. The system utilizes a tablet or other remote control to adjust the direction of the canister and view delivery information.

In yet another embodiment of the present invention, a personal mail and package delivery system is disclosed. The system uses a tablet for providing instructions to a delivery location, such as a mailbox and for receiving notifications from a scanner concerning the status of an item to be delivered and a receiving slot. The tablet is configured to receive a notification from the scanner when a package is scanned and delivered at the delivery receptacle. Further, the tablet is configured to receive a notification when a piece of mail, parcel or other item(s) is located inside of the mailbox, and a flag position indicator that is located on mailbox to indicate whether the flag is in the up or down position. The tablet is also used for instructing a compressor to provide a pushing force from the mailbox to the receiving slot when mail is placed inside the mailbox and for providing a pushing force from the receiving slot to the mailbox when there is outgoing mail positioned in the receiving slot. The mail is stored or placed within a courier canister and the canister is pushed by the compressor along a pneumatic tube which connects the mailbox and the receiving slot.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a perspective view of one potential embodiment of a pneumatic mail delivery system of the present invention in accordance with the disclosed architecture;

FIG. 1B illustrates a front view of one potential embodiment of a pneumatic mail delivery system of the present invention in accordance with the disclosed architecture;

FIG. 2A illustrates one potential embodiment of the courier canister or shuttle used for carrying mail or other items from the mailbox or delivery point to the receiving slot, and vice versa in accordance with the disclosed architecture;

FIG. 2B illustrates another potential embodiment of the courier canister or shuttle used for carrying mail or other items from the mailbox or delivery point to the receiving slot and vice versa in accordance with the disclosed architecture;

FIG. 3 illustrates a block diagram showing the exemplary components and sensors of one potential embodiment of a pneumatic mail delivery system of the present invention in accordance with the disclosed architecture;

FIG. 4 illustrates a perspective view of one potential embodiment of the scanner in use by a delivery person for scanning a package in accordance with the disclosed architecture;

FIG. 5 illustrates a schematic view of the communication between the receiving slot, mailbox and scanner with the tablet for providing necessary notifications and also enabling a resident or user to control the pneumatic mail delivery system of the present invention in accordance with the disclosed structure; and

FIG. 6 illustrates a flow diagram showing the exemplary steps of using one potential embodiment of the pneumatic mail delivery system of the present invention for receiving mail and other items inside a home or business in accordance with the disclosed specification.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a mail delivery system that can deliver packages and envelopes directly into the home or other user location. There exists a long felt need in the art for a delivery system and delivery receptacle that prevents people from constantly going out and retrieving items from the mailbox or delivery receptacle. Additionally, there is a long felt need in the art for a mail delivery system which eliminates the need to travel long distances to the mailbox or delivery location. Moreover, there is a long felt need in the art for a mailbox that notifies and alerts residents and other users about the status of their mail and other delivered items. Further, there is a long felt need in the art for a personal package delivery and notification system that allows homeowners and other users to put mail or other items in the mailbox or delivery receptacle from inside the home or user location. Furthermore, there is a long felt need in the art for a mailbox that allows homeowners or other users to change the status of the flag of the mailbox. Finally, there is a long felt need in the art for an improved mail delivery system that allows users to monitor their mailbox or delivery receptacle from the safety of their home and enables user to directly receive and send the mail and packages directly from the home or user location.

The present invention, in one exemplary embodiment, is a novel mailbox or delivery receptacle configured to work with a pneumatic tube is disclosed. The mailbox or delivery receptacle is positioned outside a house and is communicatively-coupled with a receiving slot positioned inside the housed or user location through the pneumatic tube that works as a conduit between the receiving slot and the mailbox. The mailbox includes a cavity for receiving a courier canister or shuttle that houses one or more incoming items, and a lockbox that includes an emergency canister. The emergency canister is configured to be used when the cavity is not operable. A processor is configured to transmit notification to a tablet, and a small light is positioned inside the house or user location that the courier canister or shuttle stores at least one incoming item. The mailbox along with the pneumatic tube is configured to send the courier canister or shuttle having the incoming item to the receiving slot through the tube, and is also configured to receive the courier canister or shuttle having the outgoing item from the receiving slot.

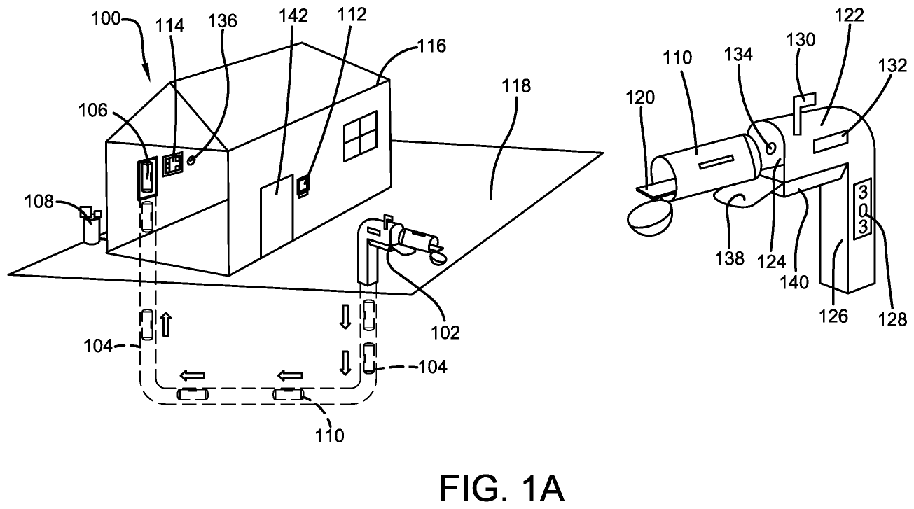

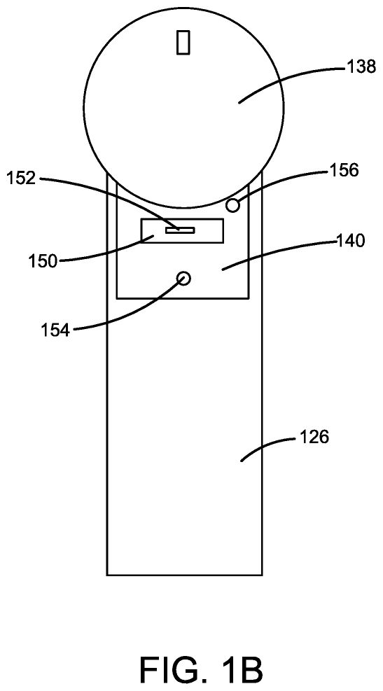

Referring initially to the drawings, FIG. 1A illustrates a perspective view of a pneumatic mail delivery system 100 and a pneumatic mailbox 102 of the present invention in accordance with the disclosed specification. The pneumatic mail delivery system 100 of the present invention is a comprehensive mail delivery system that is designed to deliver packages, items and envelopes directly into the home or user location without requiring people to constantly go out and retrieve items from the mailbox each day. More specifically, the mail delivery system 100 includes a pneumatic mailbox 102, pneumatic tube system 104, receiving slot 106, compressor 108, courier canister 110, scanner 112 and a tablet 114. The pneumatic mailbox 102 is connected to receiving slot 106 located inside a home 116 through the pneumatic tube system 104. The pneumatic tube system 104 is powered by the compressor 108 that propels the courier canister 110 from the mailbox 102 to the receiving slot 106. The delivery receptacle and receiving slot are disposed remotely from one another, such as for example the delivery receptacle is at the curb of a street and the receiving slot is in the door of a house.

The pneumatic tube system 104 may include a tube of any desired length, radius, material, connections, bends or the like for connecting and providing a conduit for the canister or shuttle 110 between the mailbox 102 installed in a yard 118 of the home or user location 116 to the receiving slot 106 inside of home or user location 116. The pneumatic tube system 104 is sized and configured allowing the canister or shuttle 110 to move forth and back from the mailbox 102 and the receiving slot 106, and may be covered with aluminum or stainless steel to assist with maintaining the pressure therein. The courier canister or shuttle 110 is configured to store items 120 that can be inserted into the canister 110 and retrieved from the canister 110. The pneumatic tube system 104 specifically defines an interior space through which the carrier 110 is guided between the mailbox 102 and the receiving slot 106.

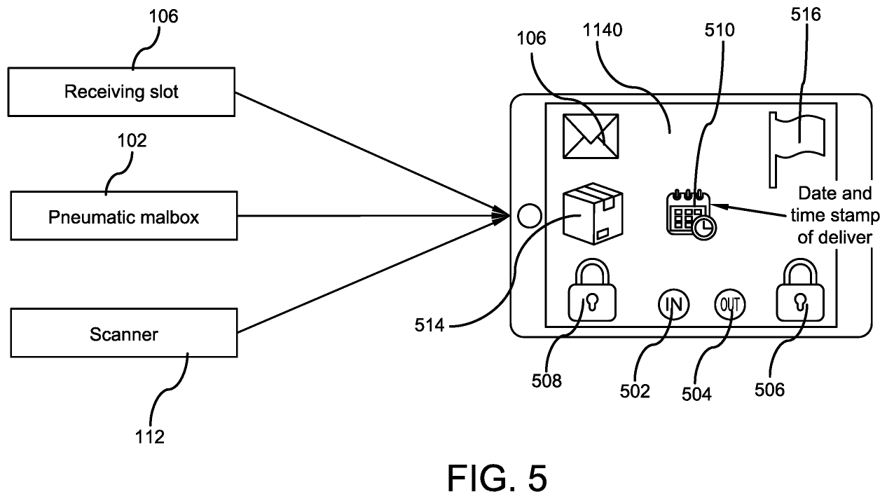

The pneumatic mailbox or delivery receptacle 102 has a frame 122 that forms an inner cavity 124. The mailbox 102 is installed using the pole 126 that can have an illuminated street number or house number 128 for easy identification of the mailbox 102. The house number 128 is illuminated using a light source such as LED so that it can be visible in low light. The frame 122 of the mailbox 102 has a flag 130 that is also known as carrier signal flag and is commonly used by homeowners, other users and business owners to alert mail couriers about the presence of mail. The carrier flag 130 in an up or vertical state denotes that there is at least one outgoing piece of mail in the mailbox 102. If the carrier flag 130 is down, then there is no outgoing mail inside the mailbox 102. In the present invention, the status of the flag can be viewed on the tablet 114 located inside the home 116. The tablet 114 is an integral part of the pneumatic mail delivery system 100 and is provided to a user when the system 100 is installed. The tablet 114 is a display device that has a software application and has various functions and features that can be used by home residents or other user to check the status of the mailbox as best described in FIG. 5.

The frame 122 also has a reflector 132 that is designed to protect the mailbox 102 from being hit by vehicles. When headlights of a passing vehicle hit the reflector 132, the reflector 132 reflects the light allowing the vehicle driver to be aware of the installation of the mailbox 102. The reflector may be made of prismatic or beaded materials such as those provided by Avery Dennison or 3M and the materials can be applied by adhesive and in various shapes or forms.

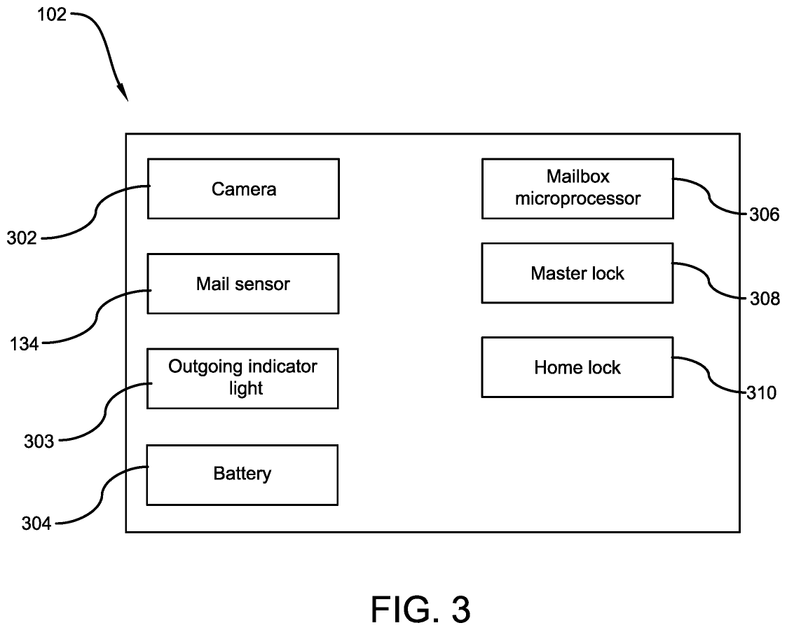

The inner cavity 124 is integrated with a sensor such as a weight sensor 134 that senses when an item is inside the mailbox 102. Alternatively, a camera (shown in FIG. 3) is positioned inside the mailbox 102 and can capture the images of the delivered items 120. When the weight sensor 134 or the camera senses or detects the presence of one or more items inside the mailbox 102, then a small light 136 is turned ON inside the home 104 to alert the resident or user that they have received an item. There can be an audible or visual notification on the tablet 114 as well. The mailbox or delivery receptacle 102 has a lid or closure flap 138 that allows a user to lock or unlock the mailbox or delivery receptacle 102. The mail or other courier such as a postman, delivery agent or courier delivery services such as USPS, FedEx etc., flips the lid or door 138 and inserts the items 120 inside the carrier 110.

FIG. 1B illustrates a front view of one potential embodiment of a pneumatic mail delivery system 100 of the present invention in accordance with the disclosed architecture. The mailbox or delivery receptacle 102 is also integrated with a lockbox 140 that can be used to place items when the carrier 110 is not present inside the mailbox or delivery receptacle 102. The lockbox 140 has a secondary storage positioned below the cavity 124 that enables a delivery person to drop items through a mail slot 150 with a handle 152 in case the resident such as a homeowner or other user has not sent their carrier 110 back to the mailbox 102 through the pneumatic tube 104 from inside their home or other location. The lockbox 140 is integrated with the home lock 154 that enables the delivery person to lock or unlock the locking box 140 after placing the items inside the lockbox 140. The lockbox 140 is also integrated with the master lock 156 that enables the user to lock the lockbox 140 automatically using the tablet 114 as shown in FIG. 5.

It should be noted that all the sensor and locks of the mailbox 102 are connected through one or more wired circuits within the mailbox 102. The wired circuits are insulated and protected from water such as rain, melting snow and ice, sprinklers and the like. The mailbox 102 also has wireless communication capabilities that allow a resident to operate and see notifications of the mailbox 102 on the tablet 114.

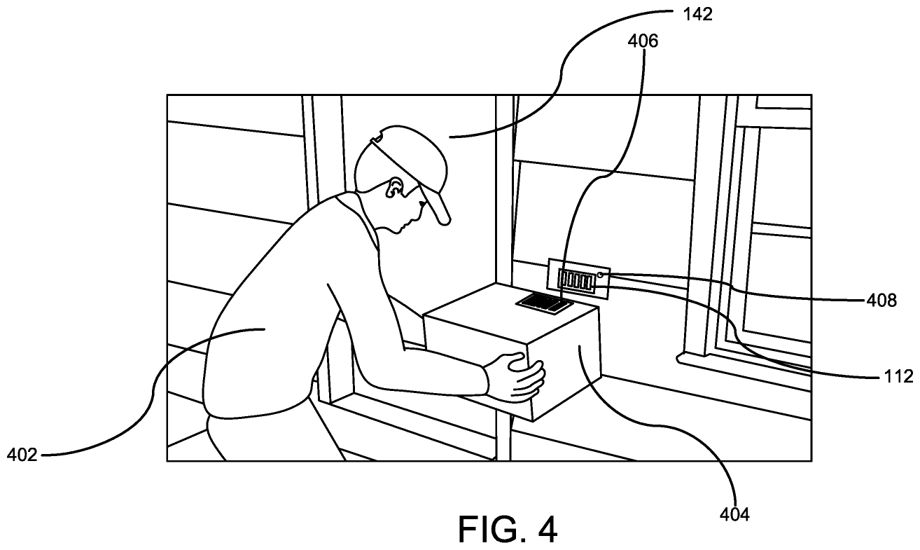

The scanner or reader 112 is positioned outside 1160 of home 116, and preferably near the door 142. The scanner or reader 112 is used by a courier or delivery person for scanning one of many packages. The scanner or reader 112 sends a notification to the tablet 114 for notifying a resident or user of a delivery service. Details of the process of scanning is best described in FIG. 4.

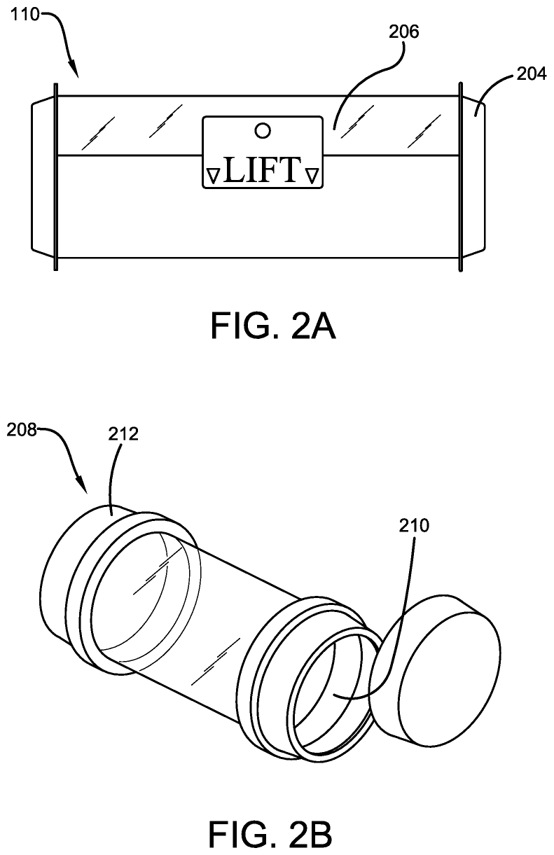

FIG. 2A illustrates a perspective view of an exemplary courier canister or shuttle 110 used for carrying items from the mailbox 102 to the receiving slot 106 and vice versa in accordance with the disclosed specification. The canister, carrier or shuttle 110 used in the pneumatic mail delivery system 100 of the present invention is in the form of a cylindrical container and is designed to store specific objects such as mail, envelopes, parcels, other delivery items or combinations thereof. The carrier or shuttle 110 is propelled/pushed through the pneumatic tubing system from the mailbox 102 to the receiving slot 106 and vice versa or via a reversible pushing force, via the compressor that creates suction or pressure. The carrier or shuttle 110 travels at a speed ranging from 20 to 50 mph with about 35 mph being preferred and depending on the pressure in the tube. The carrier 110 generally has two openings: a front opening 202 and a rear opening 204. The openings 202, 204 are used for placing items and taking items out from the carrier or shuttle 110. As an example, a mail courier can flip the front opening 202 for inserting the items inside the carrier 110. The carrier 110 is also integrated with a slide opening 206 so that a resident or user can easily access the stored items. Users such as homeowners, or residents can lift the side opening 206 to access the items inside the carrier 110. The carrier 110 can be made of plastic, such as for instance polyethylene, high-density polyethylene, metal or any other such type of materials. The carrier 110 can vary in size and can be replaceable.

When activated, the compressor 108 creates the appropriate air differential within the tube 104 to convey the carrier or shuttle 110. A pushing force due to the compressor 108 causes the carrier 110 to be conveyed between the mailbox 102 and the receiving slot 106 at a speed between 20 and 50 mph.

FIG. 2B illustrates a perspective view showing another embodiment of the courier canister used for carrying items from the mailbox 102 to the receiving slot 106 and vice versa, in accordance with the disclosed specification. The canister 208 of the present embodiment does not have a side opening, however the canister or shuttle has a front opening 210 and a rear opening 212. The canister or shuttle 208 can be used as an emergency canister in case of any technical difficulties in the pneumatic system of the present invention and is used for manual operation both by a courier and a resident. The canister 208 can also be positioned underneath the mailbox for manual use and retrieval later by the user or resident.

FIG. 3 illustrates a block diagram showing exemplary components and sensors of the pneumatic mailbox or delivery receptacle 102 of the present invention in accordance with the disclosed specification. The outside mailbox 102 has an integrated camera 302 that is designed to continuously monitor the delivery receptacle for the benefit of the user or homeowner for deliveries or pickups. The camera 302 continuously monitors the mailbox 102 and records the user who is placing mail or packages inside the carrier of the mailbox 102. Recording can also be transmitted to the tablet 114 for review of the resident or user. It should be appreciated that users and/or homeowners may receive real-time alerts of the mailbox 100. The camera 302 of the mailbox 102 is useful to keep an eye on the deliveries and pickups which reduces the risk of theft. The sensor 134 is configured to detect mail or packages being inserted into carrier 110 inside the mailbox 102. The sensor 134 is operatively-connected to the mailbox microprocessor 306 that generates real-time alerts or notifications. As stated earlier, when the sensor 134 detects items inside the carrier, it activates a small light inside of the home to alert the resident or user that they have received an item that requires retrieval, and the resident or individual using the tablet can adjust the direction of the carrier to receive the items inside of home at the receiving slot. The outside mailbox 102 is also integrated with a small outgoing indicator light 303. The small outgoing indicator light 303 notifies a courier about outgoing mail positioned inside the mailbox 102.

The mailbox 102 has a battery 304 that provides power to the components of the mailbox 102. The outside mailbox 102 can also be integrated with a durable solar panel to absorb solar energy and convert the energy into electrical energy for keeping the battery 304 charged. A master lock 308 is configured to lock the mailbox 102 and deactivate the pneumatic system. A home lock 310 is used to lock and access the lock box and can be used in emergency systems manually.

FIG. 4 illustrates a perspective view showing the scanner 112 in use by a delivery person for scanning or reading a package in accordance with the disclosed specification. As shown in FIG. 4, the scanner 112 is placed next to the door 142 of the house or other user location 116. The scanner 112 enables a courier delivery person 402 to scan a code, such as a bar code or QR code 406, or read a tag, such as an RFID tag 406, on a package 404 before delivery. The package 404 is integrated with a tag 406 such as a bar code, QR code or RFID tag that enables the delivery person 402 to scan the package 404 and identify whether the package 404 is delivered to the correct address. The delivery person 402 may only scan one of many packages addressed to the home 116. On successful scanning, the scanner 112 transmits a notification to the tablet (shown in FIG. 5) concerning the status of the delivered package and the courier company. The delivery person 402 can also take one or more pictures of the package 404 once delivered and can upload the image of the package at the delivery location onto the tablet for the resident or user to view. The scanner or reader 112 has an integrated indication light 408 that flashes in Red which indicates that the scanner 112 has power and can be used for scanning the package 404. When the courier delivery person 402 scans the package 404, the indication light 408 flashes in Green for a predetermined time, such as in the range of five to ten seconds, that indicates that the package is delivered to the right house and package has been confirmed.

The scanner 112 is configured to scan any type of tag such as a barcode, QR code, magnetic code, or RFID tag (UHF, RF, LF) and transmit the information to the tablet using a wireless communication channel such as Bluetooth, or any other short or long-range wireless communication channel.

FIG. 5 illustrates a schematic view showing communication of a receiving slot 106, mailbox 102 and scanner 112, with the tablet 114 for providing necessary notifications and also enabling a resident or user to control the pneumatic system 100 of the present invention in accordance with the disclosed disclosure. The tablet 114 is a display device that has an installed software application for enabling a resident or user to control and monitor the system 100 and its components from inside the house or other user location. The tablet 114 is similar to a tablet that may have a touch interface for providing control commands to the tablet. The tablet 114 provides a plurality of control options to the resident for controlling the mailbox or delivery receptacle 102 while providing notifications about the packages and other items received in the mailbox 102 and scanned by the scanner or reader 112.

The tablet 114 is positioned inside of the home or user location and enables a resident or user to adjust and control the direction of the carrier, canister or shuttle, and view various types of delivery information. The tablet 114 has the installed software application downloaded 1140. The tablet 114 provides an “IN” control button 502 that enables the resident or user to receive the carrier, canister or shuttle from the pneumatic mailbox or delivery receptacle 102 directly to the receiving slot 106 via the pneumatic tube system 104. When the resident or user activates the “IN” soft button 502, the carrier or shuttle 110 is propelled from the mailbox 102 to the receiving slot 106. The compressor of the pneumatic system actuates a pushing force for the canister from the mailbox 102 to the receiving slot 106. The tablet 114 also provides user with an “OUT” button 504 that enables users to push back the carrier or shuttle 110 for sending their outgoing mail or other items to the mailbox or delivery receptacle 102 from the inside of the home. In this case, the compressor of the pneumatic system actuates a pushing force for the canister from the receiving slot 106 to the mailbox or delivery receptacle 102.

The tablet 114 displays the status 506 of the lockbox. The lockbox icon 506 indicates the status of the lockbox and alerts the user if an item is placed inside the lockbox. The tablet 304 also displays the lock or unlock screen option 508 that allows a user to lock the tablet 114 when not in use. The tablet 114 notifies the resident or user about the date and time 510 of the deliveries, such as items 512 or packages 514. The item option 512 provides a notification to indicate that an item is located inside the carrier 110, or lockbox 140 of the delivery receptacle. It should be appreciated that a notification is automatically sent to the tablet 114 from the mailbox or delivery receptacle 102 when an item is placed inside the mailbox 102. Similarly, a notification is also shown on the tablet 114 when a canister or shuttle 110 has an item is placed in the receiving slot 106.

The package option 514 alerts a resident or user when a courier delivery person scans a package at scanner 112 positioned near the front door, and notifies a resident about which courier service has delivered the package. The pop-up notification generated by the scanner 112 to the resident's tablet 114 indicates the courier services such as Fedex, USPS, DHL, USPS, or any such type of courier service that has delivered the package. The tablet 114 also displays the flag option 516 that enables a user to control the flag position integrated on the frame of the mailbox or delivery receptacle 102. The tablet 114 can also allow a user to control the outgoing indicator light 302 integrated on the frame of the mailbox or delivery receptacle to indicate that there are outgoing items present inside the carrier 110. The tablet 114 can also enable a user to lock and/or unlock the main door of the mailbox 102. In one embodiment, the alerts shown on the tablet 114 are in the form of the audio alerts that indicate that the mailbox 102 is open and there are items inside the carrier 110 positioned in the cavity 124.

The alert or notification shown on the tablet 114 can be in the form of a push notification, a visual alert such as picture, video footage or current status of the mailbox or delivery receptacle.

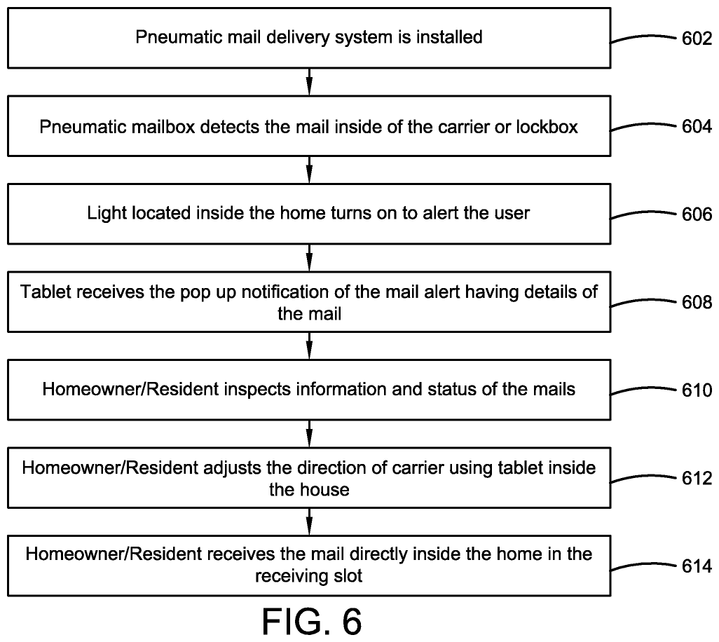

FIG. 6 illustrates a flow diagram showing exemplary steps in performing operation of the pneumatic mail delivery system of the present invention for receiving mail inside the home in accordance with the disclosed specification. As shown in FIG. 6, a pneumatic mail delivery system is initially setup between the user location and the delivery area, such as the inside and outside of the house. A pneumatic tube as a conduit is installed along with a compressor for delivering items. The pneumatic tubing system utilizes a vent or a fan (using a compressor) to carry items in canisters through the tubing from the mailbox or the delivery receptacle to the home interior and vice versa (Block 602). Integrated sensors located inside the canister, cavity and the lockbox detect the items placed in the carrier of the mailbox or the lockbox present below the mailbox (Block 604). When one of the sensors detects the items, then, the light present inside the house turns on to alert the resident that they have received items (Block 606). Simultaneously or after few seconds, the tablet positioned inside the house receives a pop-up notification indicating that the items are placed (Block 608). Thereafter, the received alert is seen and reviewed by user, resident or homeowner to check the status and other information of the item (Block 610). Then, the resident or user adjusts the direction of the carrier, canister or shuttle from the mailbox to the receiving slot inside of the home or user location using the tablet (Block 612). The pneumatic tubing system carries the items through the tubing from the mailbox to the home interior and accordingly, the resident directly receives the items inside the house (Block 614).

In use, the pneumatic mail delivery system 100 and pneumatic mailbox 102 function as a postal or courier device that provides security and safety measures users, homeowners and residents. The system 100 allows items and packages to be rapidly and securely received without a user going outside. The system 100 provides security with control through the tablet 114 and scanning of the packages through the scanner 112. An advantage of the present invention is its ability to provide users, homeowners and residents the privilege of avoiding inclement and dangerous trips to the mailbox or other delivery locations 102.

Automatic delivery of the mail or other items using the carrier, canister or shuttle also enables a mail or courier delivery person to quickly deliver mail or other items to one or more residences or user locations. This is especially advantageous when delivering mail or other items to a plurality of mailbox or delivery receptacle terminals housed in a single cabinet, for example at an apartment complex.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pneumatic mail delivery system”, “mail delivery system”, “comprehensive mail delivery system” and “system”, are interchangeable and refer to the pneumatic mail delivery system 100 of the present invention. Similarly, as used herein “pneumatic mailbox”, “outside mailbox”, and “mailbox”, are interchangeable and refer to the pneumatic mailbox 102 of the present invention.

Notwithstanding the forgoing, the pneumatic mail delivery system 100 and the pneumatic mailbox 102 of the present invention can be of any suitable size and configuration as is known in the art without affecting the overall concept of the invention, provided that it accomplishes the above-stated objectives. One of ordinary skill in the art will appreciate that the size, configuration, and material of the pneumatic mail delivery system 100 and the pneumatic mailbox 102 as shown in the FIGS. are for illustrative purposes only, and that many other sizes and shapes of the pneumatic mail delivery system 100 and the pneumatic mailbox 102 are well within the scope of the present disclosure. Although the dimensions of the pneumatic mail delivery system 100 and the pneumatic mailbox 102 are important design parameters for user convenience, the pneumatic mail delivery system 100 and the pneumatic mailbox 102 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A personal delivery system comprising;
a delivery receptacle provided for receiving a mail, courier item or combination thereof;
a receiving slot for receiving the mail, courier item or combination thereof placed in the delivery receptacle;
at least one shuttle sized and configured to hold at least one of the mail, courier package or combination thereof; and
a tube system for transporting the at least one shuttle, wherein the delivery receptacle and the receiving slot are provided on opposite ends of the tube system.

2. The personal delivery system as recited in claim 1, wherein the tube system is a pneumatic tube system.

3. The personal delivery system as recited in claim 2, wherein the pneumatic tube system creates a pushing force to propel the at least one shuttle at a speed of between 20 and 50 mph.

4. The personal delivery system as recited in claim 3, wherein the pneumatic tube system creates a pushing force to propel the shuttle at about a speed of 35 mph.

5. The personal delivery system as recited in claim 1, wherein the delivery receptacle is a mailbox.

6. The personal delivery system as recited in claim 1, wherein the delivery receptacle has a closure flap that is lockable.

7. The personal delivery system as recited in claim 1, wherein the delivery receptacle is disposed at a location remote from the receiving slot.

8. The personal delivery system as recited in claim 1 further comprising a tablet to track an information related to the mail, courier item or combination thereof.

9. The personal delivery system as recited in claim 1, wherein the delivery receptacle comprises at least one sensor to detect whether the mail, courier item or combination thereof is present in the delivery receptacle.

10. The personal delivery system as recited in claim 1, wherein the receiving slot comprises an indicator light.

11. A pneumatic mail delivery system comprising:
a mailbox having a lockable closure;
a receiving slot disposed in a house of a user;
a pneumatic tube connected to the mailbox and the receiving slot, wherein the pneumatic tube provides a reversible pushing force between the mailbox and receiving slot;
a shuttle that is sized and configured to fit within the pneumatic tube, wherein the shuttle comprises a door for receiving an article of mail for a user;
a tablet having a software program for operating the pneumatic tube and sending the article of mail in the pneumatic tube; and
an indicator light positioned at the receiving slot.

12. The pneumatic mail delivery system as recited in claim 11, wherein the reversible pushing force causes the shuttle to travel at a speed that is between 20 and 50 mph.

13. The pneumatic mail delivery system as recited in claim 12, wherein the speed is about 35 mph.

14. The pneumatic mail delivery system as recited in claim 11, wherein the mailbox comprises a sensor for determining whether the article of mail is in the mailbox.

15. The pneumatic mail delivery system as recited in claim 11, wherein the tablet can determine whether a flag on the mailbox is in an up position or a down position.

16. The pneumatic mail delivery system as recited in claim 11, wherein the mailbox comprises a reflector manufactured of a prismatic or beaded material.

17. The pneumatic mail delivery system as recited in claim 11 further comprising a scanner for reading one of a code or an RFID tag.

18. A residential system for mail and parcel delivery comprising:
a pneumatic system having a mailbox and a receiving slot with a pneumatic tube disposed between the mailbox and receiving slot;
a compressor for creating a pushing force in the pneumatic tube;
a parcel delivery scanner for reading one of a bar code, a QR code or a RFID tag, the parcel delivery scanner located near the receiving slot;
a shuttle for traveling in the pneumatic tube and sized and configured for receiving an article of mail;
the mailbox having a lockable door; and
a table connected to each of the mailbox and the parcel delivery scanner for receiving information on deliveries.

19. The residential system for mail and parcel delivery as recited in claim 18, wherein a speed of the shuttle is between 20 and 50 mph.

20. The residential system for mail and parcel delivery as recited in claim 18, wherein the RFID tag is one of an UHF tag, a HF tag or a LF tag.
